(19) United States
(12) Patent Application Publication
(10) Pub. No.: US 2020/0398654 A1
(43) Pub. Date: Dec. 24, 2020

(54) POWER TRANSMISSION DEVICE

(71) Applicant: AISIN AW CO., LTD., Anjo-shi, Aichi-ken (JP)

(72) Inventors: Yasuki NISHIZAWA, Anjo (JP); Wataru SAKAKIBARA, Anjo (JP)

(73) Assignee: AISIN AW CO., LTD., Anjo-shi, Aichi-ken (JP)

(21) Appl. No.: 16/960,611

(22) PCT Filed: Jan. 7, 2019
(86) PCT No.: PCT/JP2019/000068

§ 371 Date: Jul. 8, 2020

(30) Foreign Application Priority Data
Feb. 28, 2018 (JP) 2018-036022

(51) Int. Cl. B60K 6/365; B60K 6/445

(52) U.S. Cl. CPC B60K 6/365; B60K 6/48; B60K 6/445

(57) ABSTRACT

A power transmission device mounted on a vehicle includes: a rotation transmission member that transmits power transmitted from a driving source to an input shaft; a power connection switching mechanism that is connected to or cut off from the driving source and the rotation transmission member; and an oil pump to which rotation of either a first rotational shaft on a driving source side of the power connection switching mechanism and a second rotational shaft on a driving wheel side of the power connection switching mechanism is selectively transmitted to drive the oil pump. The oil pump is coupled to the second rotational shaft via a gear transmission mechanism in which a plurality of gears mesh with each other. A first rotation ratio of the first rotational shaft and the oil pump, and a second rotation ratio of the second rotational shaft and the oil pump are different.

### CROSS REFERENCE TO RELATED APPLICATIONS

This application is a National Stage of International Application No. PCT/JP2019/000068 filed Jan. 7, 2019, claiming priority based on Japanese Patent Application No. 2018-036022 filed Feb. 28, 2018 the contents of which are incorporated in their entirety.

### TECHNICAL FIELD

The present disclosure relates to a power transmission device.

### BACKGROUND ART

Conventionally, as this type of power transmission device, a power transmission device mounted on a vehicle having: a continuously variable transmission that changes a speed of power in a stepless manner, and that transmits power between a primary shaft, which is connected to an engine via a torque converter and a clutch and also connected to a motor, and a secondary shaft; and an oil pump to which rotation of either the engine or the primary shaft is selectively transmitted to drive the oil pump (for example, see Patent Document 1). In the power transmission device, a first chain is looped around a first sprocket provided on a pump drive shaft of the oil pump and a second sprocket provided on a one-way clutch provided on a primary shaft and thus, a first power transmission mechanism is configured. A second chain is looped around a third sprocket provided on the pump drive shaft of the oil pump and a fourth sprocket provided on a one-way clutch provided on a hollow shaft of pump impeller of a torque converter and thus, a second power transmission mechanism is configured.

### RELATED ART DOCUMENTS

### Patent Documents

Patent Document 1: Japanese Unexamined Patent Application Publication No. 2014-231321 (JP 2014-231321 A)

### SUMMARY OF THE DISCLOSURE

When both the first and second power transmission mechanisms are configured of a chain mechanism having a sprocket and a chain, it is difficult to adjust a relationship between a first rotation ratio and a second rotation ratio (for example, the first rotation ratio divided by the second rotation ratio) when the first rotation ratio of the engine (the pump impeller of the torque converter) and the pump drive shaft and the second rotation ratio of the primary shaft of the continuously variable transmission and the pump drive shaft are set to be values different from each other. This is because a distance between pins of the chain, that is, a pitch, is defined in steps according to a standard, and the total length of the chain is determined by an integral multiple of the pitch and thus, it is difficult to set the chain at a desired length.

A power transmission device of the present disclosure includes an oil pump to which rotation of either a first rotational shaft on a driving source side or a second rotational shaft on a driving wheel side is selectively transmitted to drive the oil pump. A main object of such a power transmission device is to facilitate adjustment of a relationship between a first rotation ratio of the first rotational shaft and the oil pump and a second rotation ratio of the second rotational shaft and the oil pump.

The power transmission device of the present disclosure adopted the following means to achieve the above main purpose.

The power transmission device of the present disclosure is a power transmission device mounted on a vehicle, including:

a rotation transmission member that transmits power transmitted from a driving source to an input shaft;

a power connection switching mechanism that is connected to or cut off from the driving source and the rotation transmission member; and

an oil pump to which rotation of either a first rotational shaft on a driving source side of the power connection switching mechanism or a second rotational shaft on a driving wheel side of the power connection switching mechanism is selectively transmitted to drive the oil pump, in which

the oil pump is coupled to the second rotational shaft via a gear transmission mechanism in which a plurality of gears mesh with each other, and

a first rotation ratio of the first rotational shaft and the oil pump, and a second rotation ratio of the second rotational shaft and the oil pump are different.

In the power transmission device of the present disclosure, the oil pump is coupled to the second rotational shaft on the driving wheel side of the power connection switching mechanism via a gear transmission mechanism in which a plurality of gears are meshed with each other. The first rotation ratio of the first rotational shaft on the driving source side of the power connection switching mechanism and the oil pump, and the second rotation ratio of the second rotational shaft and the oil pump are different. Thus, since the second rotational shaft and the oil pump are coupled via the gear transmission mechanism, it is possible to facilitate adjustment of the relationship between the first rotation ratio and the second rotation ratio (for example, the first rotation ratio divided by the second rotation ratio). That is, the relationship between the first rotation ratio and the second rotation ratio can have more flexibility.

### BRIEF DESCRIPTION OF THE DRAWINGS

FIG. 1 is a schematic configuration diagram of a power transmission device 20 of the present disclosure.

FIG. 2 is schematic configuration diagram of a part of the power transmission device 20.

FIG. 3 is an explanatory diagram of a position relationship of an oil chamber forming portion 810 of a transaxle case 81, an oil pump 60, and a gear transmission mechanism 72, when viewed from the left side in FIG. 1 and FIG. 2.

FIG. 4 is a schematic configuration diagram of a part of a unit A.

FIG. 5 is a schematic configuration diagram of a part of a unit B.

FIG. 6 is a schematic configuration diagram of a part of a power transmission device 20B.

FIG. 7 is a schematic configuration diagram of a part of a power transmission device 20C.

### DETAILED DESCRIPTION

Modes for carrying out various aspects of the present disclosure will be described below with reference to the accompanying drawings.

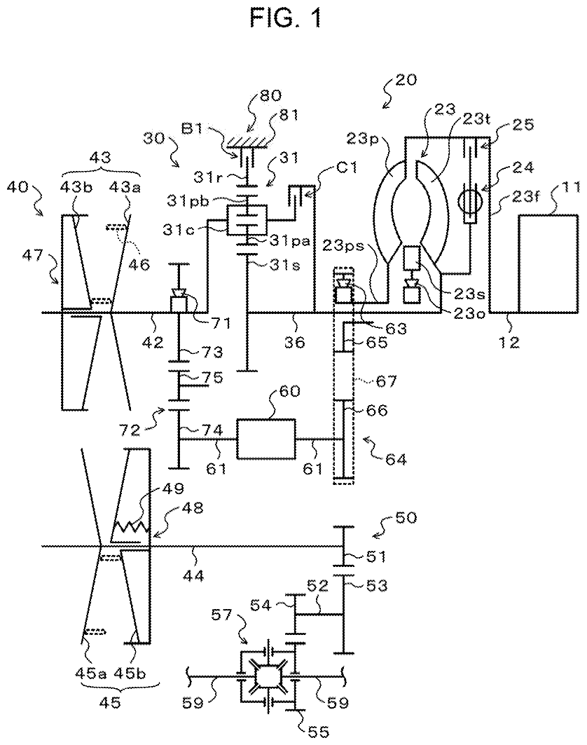

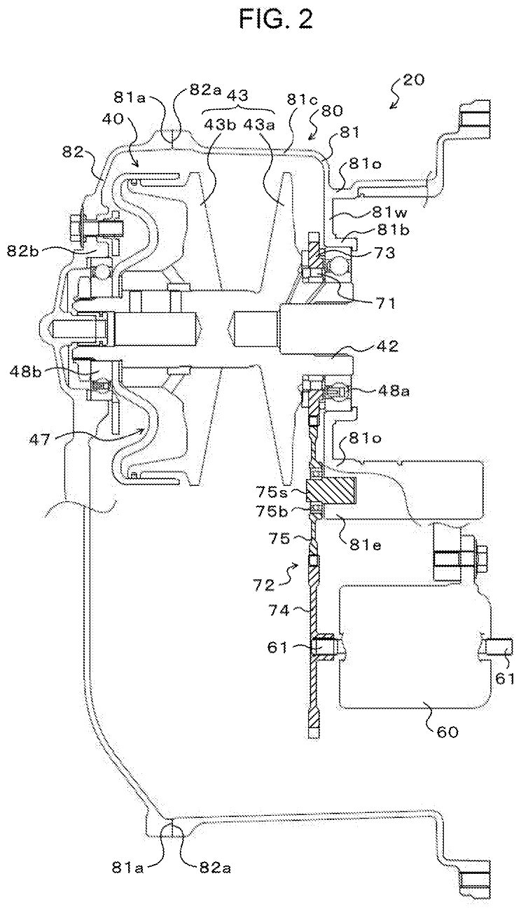

FIG. 1 is a schematic configuration diagram of a power transmission device 20 of the present disclosure. FIG. 2 is a schematic configuration diagram of a part of the power transmission device 20. The power transmission device 20 is mounted on a front wheel drive vehicle, and is configured as a transaxle coupled to an engine 11 that is disposed transversely so that a crankshaft 12 of the engine 11 and left and right drive shafts 59 connected to driving wheels (not shown) are substantially in parallel. As illustrated in FIG. 1 and FIG. 2, the power transmission device 20 has a transmission case 80, a starting device 23 housed inside the transmission case 80, a forward/reverse travel switching mechanism 30, a belt-type continuously variable transmission (hereinafter referred to as a “CVT”) 40 serving as a rotation transmission member, a gear mechanism 50, a differential gear (differential mechanism) 57, an oil pump 60, and the like.

As illustrated in FIG. 2, the transmission case 80 has a transaxle case (first case member) 81 and a rear case (second case member) 82. The two are connected while a contact surface 81a of the transaxle case 81 and a contact surface 82a of the rear case 82 abut against each other. The transaxle case 81 has a tubular outer tube portion 81c and a center support (inner wall portion) 81w extending radially inward from an inner peripheral surface of the outer tube portion 81c.

The starting device 23 is configured as a fluid starting device with a lock-up clutch and is housed inside the transaxle case 81 (see FIG. 2). As illustrated in FIG. 1, the starting device 23 has a pump impeller 23p connected to the crankshaft 12 of the engine 11 via a front cover 23f serving as an input member, a turbine runner 23t fixed to an input shaft 36, a stator 23s disposed inward of the pump impeller 23p and the turbine runner 23t to adjust the flow of working oil (ATF) from the turbine runner 23t to the pump impeller 23p, a one-way clutch 23o that restricts rotation of the stator 23s to one direction, a damper mechanism 24, a lock-up clutch 25, and the like.

The pump impeller 23p, the turbine runner 23t, and the stator 23s function as a torque converter through the action of the stator 23s when the rotational speed difference between the pump impeller 23p and the turbine runner 23t is large, and function as a fluid coupling when a rotational speed difference between the pump impeller 23p and the turbine runner 23t is small. However, the starting device 23 may not be provided with the stator 23s and the one-way clutch 23o so that the pump impeller 23p and the turbine runner 23t function only as a fluid coupling.

The damper mechanism 24 has an input element coupled to the lock-up clutch 25, an output element that is coupled to the input element via a plurality of elastic bodies and that is fixed to a turbine hub, and the like. The lock-up clutch 25 selectively establishes and releases lock-up in which the pump impeller 23p and the turbine runner 23t, that is, the front cover 23f and the input shaft 36, are mechanically coupled to each other (via the damper mechanism 24). The lock-up clutch 25 may be configured as a hydraulic single-plate friction clutch, or may be constituted as a hydraulic multi-plate friction clutch.

The forward/reverse travel switching mechanism 30 is housed inside the transaxle case 81 and has a double pinion-type planetary gear mechanism 31, a brake B1 and a clutch (power connection switching mechanism) C1 serving as hydraulic friction engagement elements. The planetary gear mechanism 31 has a sun gear 31s fixed to the input shaft 36, a ring gear 31r, and a carrier 31c that supports a pinion gear 31pa meshed with the sun gear 31s and a pinion gear 31pb meshed with the ring gear 31r and that is coupled to a primary shaft 42 of the CVT 40.

The brake B1 disengages the ring gear 31r of the planetary gear mechanism 31 from the transaxle case 81 so that the ring gear 31r is rotatable, and fixes the ring gear 31r of the planetary gear mechanism 31 to the transaxle case 81 so that the ring gear 31r is stationary when hydraulic pressure is supplied from a hydraulic control device. The clutch C1 disengages the carrier 31c of the planetary gear mechanism 31 from the input shaft 36 (sun gear 31s) so that the carrier 31c is rotatable, and couples the carrier 31c of the planetary gear mechanism 31 to the input shaft 36 (sun gear 31) when hydraulic pressure is supplied from the hydraulic control device.

A hydraulic brake having a hydraulic servo configured of a piston, a plurality of friction engagement plates (friction plates and separator plates), and an oil chamber (an engagement oil chamber and a cancel oil chamber) to which working oil is supplied is adopted as the brake B1. A hydraulic clutch having a hydraulic servo configured of a piston, a plurality of friction engagement plates (friction plates and separator plates), an oil chamber (an engagement oil chamber and a cancel oil chamber) to which working oil is supplied is adopted as the clutch C1.

With such a configuration, by disengaging the brake B1 and engaging the clutch C1, it is possible to transmit power transmitted to the input shaft 36 as it is to the primary shaft 42 of the CVT 40 to drive a vehicle forward. Further, by engaging the brake B1 and disengaging the clutch C1, it is possible to transmit rotation of the input shaft 36 to the primary shaft 42 of the CVT 40 with the direction of the rotation inverted, to drive the vehicle rearward. Moreover, by disengaging the brake B1 and the clutch C1, it is possible to release connection between the input shaft 36 and the primary shaft 42.

The CVT 40 has: a primary pulley 43 provided on the primary shaft (first shaft) 42 serving as a driving rotational shaft; a secondary pulley 45 provided on a secondary shaft (second shaft) 44 serving as a driven rotational shaft disposed in parallel with the primary shaft 42; a transmission belt 46 that extends between a pulley groove of the primary pulley 43 and a pulley groove of the secondary pulley 45; a primary cylinder 47 that is a hydraulic actuator that changes a width of the groove of the primary pulley 43; and a secondary cylinder 48 that is a hydraulic actuator that changes a width of the groove of the secondary pulley 45.

As illustrated in FIG. 2, the primary shaft 42 is rotatably supported by a cylindrical support portion 81b formed on an inner peripheral side of the center support 81w of the transaxle case 81 via a bearing 48a, and the primary shaft 42 is rotatably supported by a cylindrical support portion 82b of the rear case 82 via a bearing 48b. Although not shown, the secondary shaft 44 is rotatably supported by a cylindrical support portion of the rear case 82 via a bearing.

As illustrated in FIG. 1 and FIG. 2, the primary pulley 43 has a fixed sheave 43a formed integrally with the primary shaft 42, and a movable sheave 43b supported by the primary shaft 42 via a ball spline etc. so as to be slidable in an axial direction. As illustrated in FIG. 1, the secondary pulley 45 has a fixed sheave 45a formed integrally with the secondary shaft 44, and a movable sheave 45b supported by the secondary shaft 44 via a ball spline etc. so as to be slidable in the axial direction and urged in the axial direction by a return spring 49 which is a compression spring.

The primary cylinder 47 is formed behind the movable sheave 43b of the primary pulley 43. The secondary cylinder 48 is formed behind the movable sheave 45b of the secondary pulley 45. Working oil is supplied from the hydraulic control device to the primary cylinder 47 and the secondary cylinder 48 so as to change the widths of the grooves of the primary pulley 43 and the secondary pulley 45. This allows the speed of power transmitted from the engine 11 to the primary shaft 42 via the starting device 23 and the forward/reverse travel switching mechanism 30 to be changed in a stepless manner and the power to be transmitted to the secondary shaft 44. The power transmitted to the secondary shaft 44 is then transmitted to the left and right driving wheels via the gear mechanism 50, the differential gear 57, and the drive shafts 59.

As illustrated in FIG. 1, the gear mechanism 50 has: a counter drive gear 51 that rotates integrally with the secondary shaft 44; a counter shaft (third shaft) 52 that extends in parallel with the secondary shaft 44 and the drive shafts 59 and that is rotatably supported by the transaxle case 81 via a bearing; a counter driven gear 53 fixed to the counter shaft 52 and meshed with the counter drive gear 51; a drive pinion gear (final drive gear) 54 formed integrally with the counter shaft 52 or fixed to the counter shaft 52; and a differential ring gear (final driven gear) 55 meshed with the drive pinion gear 54 and coupled to the differential gear 57 that is coupled to the drive shafts 59.

As illustrated in FIG. 1 and FIG. 2, the oil pump 60 is configured as a mechanical oil pump that sucks working oil in an oil pan (not shown) by rotation of a pump shaft 61 and supplies hydraulic pressure to the hydraulic control device. In the axial direction of the power transmission device 20 (CVT 40), the oil pump 60 is coupled to a rotational shaft 23ps via a one-way clutch 63 and a wrapping transfer mechanism 64 on the engine 11 side of the center support 81w, and the oil pump 60 is coupled to the primary shaft 42 of the CVT 40 via a one-way clutch 71 and a gear transmission mechanism 72 on the opposite side of the center support 81w from the engine 11. The rotational shaft 23ps is coupled to the pump impeller 23p and is rotatably supported by the input shaft 36.

Here, as illustrated FIG. 1, the wrapping transfer mechanism 64 has a sprocket 65 that is attached via a one-way clutch 63 to the rotational shaft 23ps coupled to the pump impeller 23p, a sprocket 66 that is attached to the pump shaft 61 of the oil pump 60, and a chain 67 that is looped around the sprocket 65 and the sprocket 66. Although the one-way clutch 63 transmits rotation from the rotational shaft 23ps to the sprocket 65, the one-way clutch 63 does not transmit rotation from the sprocket 65 to the rotational shaft 23ps. By attaching the one-way clutch 63 to the rotational shaft 23ps, lubricating oil can be supplied to the one-way clutch 63 from an oil passage and the like formed in the input shaft 36, and the one-way clutch 63 can be easily lubricated.

As illustrated in FIG. 1 and FIG. 2, a gear transmission mechanism 72 has: a drive gear 73 attached to the primary shaft 42 via a one-way clutch 71, between the primary pulley 43 of the CVT 40 and the forward/reverse switching mechanism 30; and a driven gear 74 attached to the pump shaft 61 of the pump 60; and an idler gear 75 that meshes with the drive gear 73 and the driven gear 74. The one-way clutch 71 is supported in the axial direction of the one-way clutch 71 (left-right direction in FIG. 2) by the fixed sheave 43a of the primary pulley 43 of the CVT 40 and the bearing 48a. Although the one-way clutch 71 transmits rotation from the primary shaft 42 to the drive gear 73, the one-way clutch 71 does not transmit rotation from the drive gear 73 to the primary shaft 42. By attaching the one-way clutch 71 to the primary shaft 42, lubricating oil can be supplied to the one-way clutch 71 from an oil passage formed in the primary shaft 42, and the one-way clutch 71 can be easily lubricated. Further, by using the idler gear 75, the rotation directions of the rotational shaft 23ps coupled to the pump impeller 23p, the primary shaft 42 of the CVT 40, and the pump shaft 61 of the oil pump 60 during forward traveling can be matched.

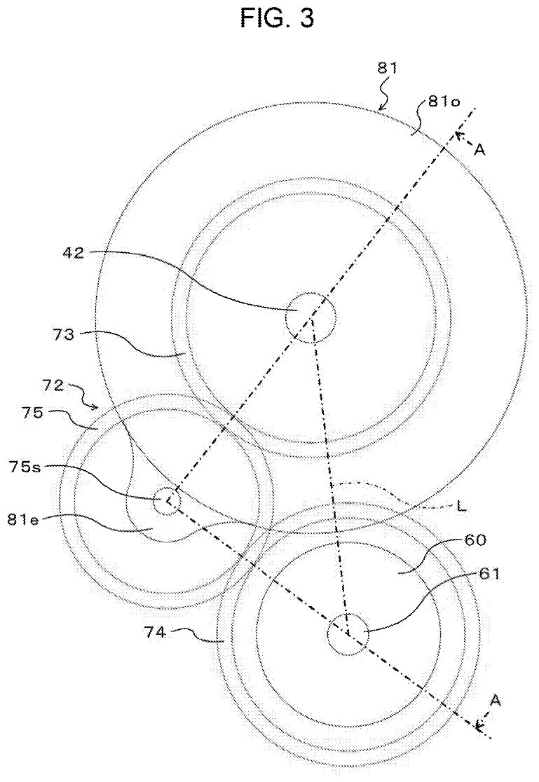

FIG. 3 is an explanatory diagram of a positional relationship of an oil chamber forming portion 810 of the transaxle case 81, the oil pump 60, and the gear transmission mechanism 72 when viewed from the left side in FIG. 1 and FIG. 2. Here, the oil chamber forming portion 810 is an annular part of the transaxle case 81 in which an oil chamber of the brake B1 of the forward/reverse travel switching mechanism 30 is formed. The oil chamber forming portion 810 of the transaxle case 81, the oil pump 60, and the gear transmission mechanism 72 in FIG. 2 correspond to a section taken along line A-A in FIG. 3. As illustrated in FIG. 2 and FIG. 3, transaxle case 81 has the oil chamber forming portion 810 and an extended portion 81e extended radially outward from an outer periphery of the oil chamber forming portion 81o, and a gear shaft 75s is fixed to the extended portion 81e. As illustrated FIG. 2, the idler gear 75 is rotatably supported by the gear shaft 75s via a bearing 75b. Further, as illustrated in FIG. 3, a shaft center of the idler gear 75 (gear shaft 75s) is provided at a position offset (displaced) from a straight line L connecting a shaft center of the drive gear 73 and a shaft center of the driven gear 74. Thus, the idler gear 75 can be shaft-supported by the extended portion 81e so that the idler gear 75 is rotatable, by effectively utilizing the space on an outer peripheral side of the oil chamber forming portion 810 while avoiding the oil chamber of the brake B1. As a result, it is possible to reduce the axial length and the length in the direction of the straight line L of the power transmission device 20. Further, the shaft center of the idler gear 75 (gear shaft 75s) is offset so as to be close to the differential shaft (drive shaft 59).

The wrapping transfer mechanism 64 and the gear transmission mechanism 72 are designed so that a rotation ratio γ2 (the rotation speed of the primary shaft 42 divided by the rotation speed of the pump shaft 61) of the primary shaft 42 of the CVT 40 and the pump shaft 61 of the oil pump 60 is smaller than a rotation ratio γ1 (the rotation speed of the rotational shaft 23ps divided by the rotation speed of the pump shaft 61) of the rotational shaft 23ps coupled to the pump impeller 23p and the pump shaft 61 of the oil pump 60, and so that the rotation ratio γ2 is less that a value of 1. Thus, when the rotation speed of the primary shaft 42 of the CVT 40 is relatively high, such as during forward traveling at a relatively high speed, the one-way clutch 63 idles and the oil pump 60 is driven by rotation of the primary shaft 42. When the rotation speed of the primary shaft 42 of the CVT 40 is relatively low, such as during forward traveling at a relatively low speed or during idle operation of the engine 11 when the vehicle is stationary, the one-way clutch 73 idles and the oil pump 60 is driven by rotation of the rotational shaft 23ps coupled to the pump impeller 23p. During rearward traveling, the oil pump 60 is driven by rotation of the rotational shaft 23ps coupled the pump impeller 23p and the one-way clutch 73 idles, since the primary shaft 42 of the CVT 40 rotates in the reverse direction.

In the present embodiment, by using the wrapping transfer mechanism 64 between the rotational shaft 23ps coupled to the pump impeller 23p and the pump shaft 61 of the oil pump 60, it is possible to reduce mass and occupied space compared to when using a gear transmission mechanism similar to the gear transmission mechanism 72. When a gear transmission mechanism similar to the gear transmission mechanism 72 is used, the longer the distance between the rotational shaft 23ps coupled to the pump impeller 23p and the pump shaft 61 of the oil pump 60 is, the larger a gear diameter becomes, and mass and occupied space is increased. Thus, the effect of using the wrapping transfer mechanism 64 becomes more significant. The effects of using the gear transmission mechanism 72 between the primary shaft 42 of the CVT 40 and the pump shaft 61 of the oil pump 60 will be described later. Further, by coupling the rotational shaft 23ps and the pump shaft 61 via the wrapping transfer mechanism 64 and coupling the primary shaft 42 and the pump shaft 61 via the gear transmission mechanism 72, the degree of freedom in a relationship between the rotation ratio γ1 of the rotational shaft 23ps and the pump shaft 61 and the rotation ratio γ2 of the primary shaft 42 and the pump shaft 61 can be increased, compared to when the two couplings are both performed via a wrapping transfer mechanism.

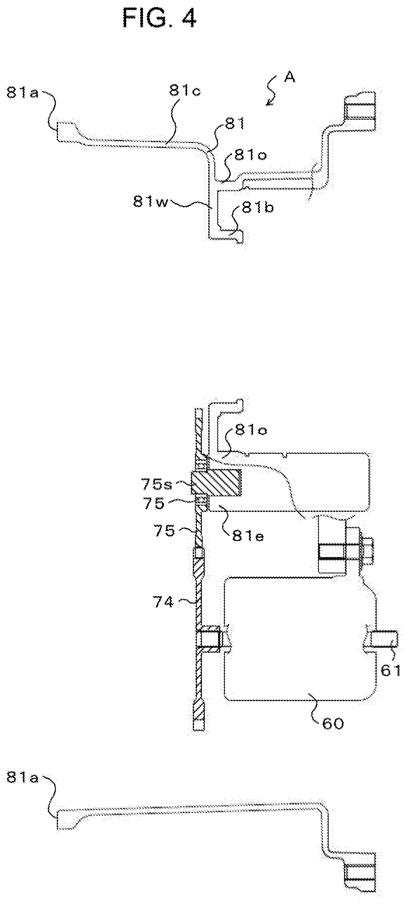

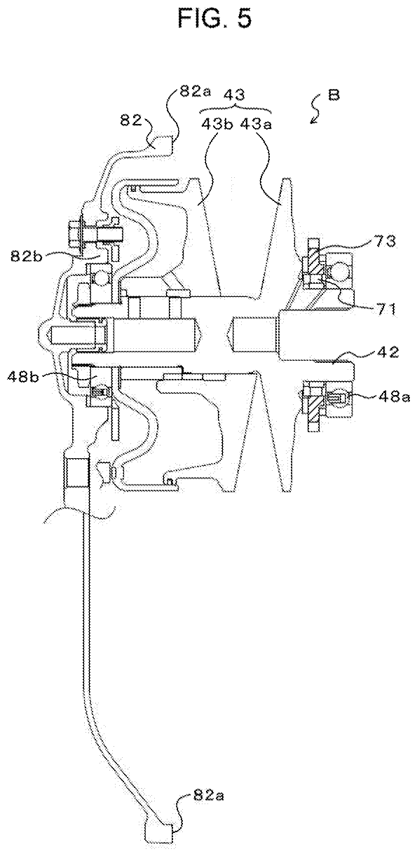

Next, an assembly process of the power transmission device 20 will be described. FIG. 4 is a schematic configuration diagram of a part of a unit A in which the transaxle case 81, the oil pump 60, the driven gear 74, the idler gear 75 and the like are integrated. FIG. 5 is a schematic configuration diagram of a part of a unit B in which the rear case 82, the CVT 40, the bearings 48a, 48b, the drive gear 73, and the like are integrated. In the assembly process of the power transmission device 20, the units A, B are integrated into the state illustrated in FIG. 2, after the units A, B are each assembled. When the units A, B are integrated, the drive gear 73 attached to the primary shaft 42 of the CVT 40 and the idler gear 75 shaft-supported by the extended portion 81e of the transaxle case 81 are meshed with each other, and the bearing 48a is fitted to the support portion 81b of the transaxle case 71. When a wrapping transfer mechanism similar to the wrapping transfer mechanism 64 (the sprockets 65, 66 and the chain 67) is used instead of the gear transmission mechanism 72 (the drive gear 73, the driven gear 74, and the idler gear 75), a chain needs to be looped around the two sprockets when the transaxle case 81 and the rear case 82 are joined integrally, which makes operation difficult. In contrast, in the present embodiment, by using the gear transmission mechanism 72, the drive gear 73 and the idler gear 75 may be engaged when the transaxle case 81 and the rear case 82 are integrally joined. Thus, workability (assemblability of the power transmission device 20) can be improved. In the present embodiment, since the drive gear 73 is supported by the primary shaft 42, the driven gear 74 is supported by the pump shaft 61 of the oil pump 60, and the idler gear 75 is supported by the transaxle case 81, the drive gear 73 can be easily assembled later with the CVT 40 (primary shaft 42).

In the power transmission device 20 described above, the transmission case 80 has the transaxle case 81 that supports the oil pump 60 and the rear case 82 that supports the CVT 40 and that is integrally joined to the transaxle case 81. In the axial direction of the power transmission device 20 (CVT 40), the oil pump 60 is coupled to the rotational shaft 23ps, which is coupled to the pump impeller 23p, via the one-way clutch 63 and the wrapping transfer mechanism 64, on the engine 11 side of the center support 81w. Also in the axial direction of the power transmission device 20 (CVT 40), the oil pump 60 is coupled to the primary shaft 42 of the CVT 40 via the one-way clutch 71 and the gear transmission mechanism 72, on the opposite side of the center support 81w from the engine 11. Using the gear transmission mechanism 72 eliminates the need of assembling while looping the chain and improves the assemblability of the power transmission device 20, compared to using a wrapping transfer mechanism similar to the wrapping transfer mechanism 64. Further, by using the wrapping transfer mechanism 64, it is possible to reduce mass and occupied space, compared to using a gear transmission mechanism similar to the gear transmission mechanism 72. In addition, it is possible to increase the degree of freedom in the relationship between the rotation ratio γ1 of the pump shaft 61 and the rotational shaft 23ps and the rotation ratio γ2 of the primary shaft 42 and the pump shaft 61, compared to when the coupling of the oil pump 60 and the rotational shaft 23ps and the coupling of the oil pump 60 and the primary shaft 42 are both performed via a wrapping transfer mechanism.

In the embodiment described above, the drive gear 73 of the gear transmission mechanism 72 is attached to the primary shaft 42 between the primary pulley 43 of the CVT 40 and the forward/reverse travel switching mechanism 30. However, the drive gear 73 may be attached to the primary shaft 42 on the opposite side of the primary pulley 43 from the forward/reverse travel switching mechanism 30. Further, the drive gear 73 may be attached to the secondary shaft 44. Also, the drive gear 73 may be attached to any rotational shaft of the gear mechanism 50.

In the above embodiment, the one-way clutch 71 is provided between the primary shaft 42 of the CVT 40 and the drive gear 73. However, the one-way clutch 71 may be provided between the gear shaft 75s and the idler gear 75 or may be provided between the pump shaft 61 of the oil pump 60 and the driven gear 74.

In the embodiment described above, the sprocket 65 of the wrapping transfer mechanism 64 is attached to the rotational shaft 23ps coupled the pump impeller 23p. However, the sprocket 65 may be attached to the crankshaft 12 of the engine 11.

In the embodiment described above, the one-way clutch 63 is provided between the rotational shaft 23ps coupled to the pump impeller 23p and the sprocket 65. However, the one-way clutch 63 may be provided between the pump shaft 61 of the oil pump 60 and the sprocket 66.

In the embodiment described above, the rotation ratio γ2 of the primary shaft 42 of the CVT 40 and the pump shaft 61 of the oil pump 60 is designed to be smaller than the rotation ratio γ1 of the rotational shaft 23ps coupled to the pump impeller 23p and the pump shaft 61 of the oil pump 60. However, the rotation ratio γ2 may be designed to be larger than the rotation ratio γ1.

In the embodiment described above, the pump shaft 61 of the oil pump 60 is coupled to a rotational shaft (specifically, the rotational shaft 23ps coupled to the pump impeller 23p) on the engine 11 side of the forward/reverse travel switching mechanism 30 via the one-way clutch 63 and the wrapping transfer mechanism 64. Also in the embodiment described above, the pump shaft 61 of the oil pump 60 is coupled to a rotational shaft (specifically, the primary shaft 42 of the CVT 40) on the drive shaft 59 side of the forward/reverse travel switching mechanism 30 via the one-way clutch 71 and the gear transmission mechanism 72. However, if the assemblability of the power transmission device 20 is satisfactory, the pump shaft 61 of the oil pump 60 may be coupled to a rotational shaft on the drive shaft 59 side of the forward/reverse travel switching mechanism 30 via the one-way clutch and the gear transmission mechanism. In addition, the pump shaft 61 may be coupled to a rotational shaft on the engine 11 side of the forward/reverse travel switching mechanism 30 via the one-way clutch and the wrapping transfer mechanism.

In the embodiment described above, the shaft center of the idler gear 75 (gear shaft 75s) is as provided at a position offset (shifted) from the straight line L connecting the shaft center of the drive gear 73 and the shaft center of the driven gear 74. However, the shaft center of the idler gear 75 may be provided on the straight line L.

In the embodiment described above, the idler gear 75 is shaft-supported by the extended portion 81e of the transaxle case 81 so that the idler gear 75 is rotatable. However, the idler gear 75 is not limited to this, and may be shaft-supported by a part other than the extended portion 81e.

In the embodiment described above, the clutch C1 of the forward/reverse travel switching mechanism 30 connects the sun gear 31s and the carrier 31c of the planetary gear mechanism 31 with each other and releases the connection therebetween. However, the clutch C1 is not limited to this, and may connect or disconnect any two of the three rotation elements of the planetary gear mechanism 31 with and from each other. Although the forward/reverse travel switching mechanism 30 has the double pinion-type planetary gear mechanism 31, the forward/reverse travel switching mechanism 30 may have a single pinion-type planetary gear mechanism instead.

Although the CVT 40 is used as the rotation transmission member in the embodiment described above, a stepped transmission may be used as the rotation transmission member.

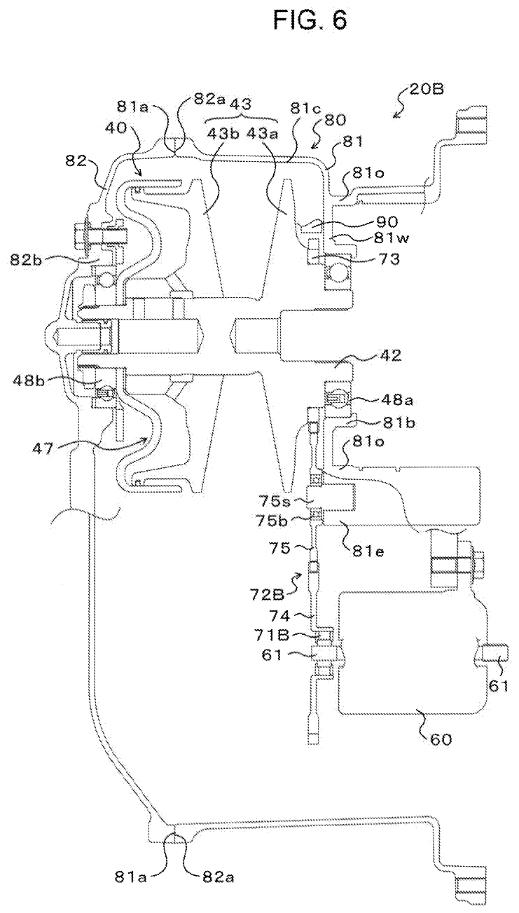

FIG. 6 is a schematic configuration diagram of a part of a power transmission device 20B according to another embodiment of the present disclosure. The power transmission device 20B of FIG. 6 has a similar configuration to that of the power transmission device 20 illustrated in FIG. 1 and FIG. 2, with the exception that the power transmission device 20B has a one-way clutch 71B and a gear transmission mechanism 72B instead of the one-way clutch 71 and the gear transmission mechanism 72 and also has a speed sensor (rotation speed sensor) 90. Thus, components of the power transmission device 20B in FIG. 6 that are the same as those in the power transmission device 20 in FIG. 1 or FIG. 2 are given the same signs and detailed description thereof will be omitted.

The gear transmission mechanism 72B has the drive gear 73, the driven gear 74, and the idler gear 75, similar to the power transmission device 20 in FIG. 1 and FIG. 2. The drive gear 73 is attached to the primary shaft 42 between the primary pulley 43 of the CVT 40 and the forward/reverse travel switching mechanism 30. The driven gear 74 is attached to the pump shaft 61 of the oil pump 60 via a one-way clutch 71B. The idler gear 75 meshes with the drive gear 73 and the driven gear 74.

The speed sensor 90 is disposed so as to face the drive gear 73 in the radial direction, and detects the rotation speed of the primary shaft 42 by sensing teeth of the drive gear 73. In such a case, the drive gear 73 also has a function of serving as a rotor of the speed sensor 90. In this way, since there is no need to provide a rotor dedicated to the speed sensor 90, the number of parts can be reduced.

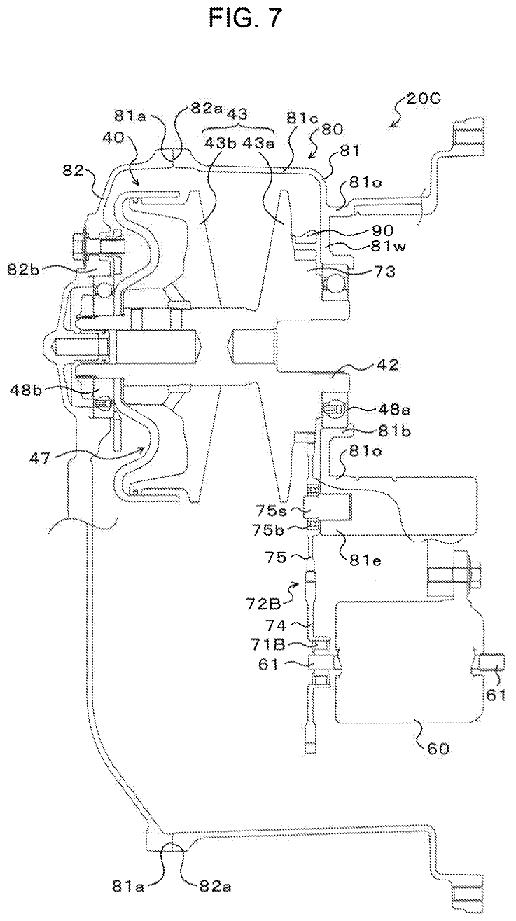

FIG. 7 is a schematic configuration diagram of a part of a power transmission device 20C that is another embodiment of the present disclosure. The power transmission device 20C in FIG. 7 is the same as the power transmission device 20B illustrated in FIG. 6 with the exception that the drive gear 73 is formed integrally with the fixed sheave 43a of the primary pulley 43 of the CVT 40.

In the power transmission devices 20B, 20C in FIG. 6 and FIG. 7, the drive gear 73 is used as a rotor of the speed sensor 90. However, the driven gear 74 and the idler gear 75 may be used as the rotor of the speed sensor 90. In such a case, the rotation speed of the driven gear 74 and the idler gear 75 detected by the speed sensor 90 may be converted into the rotation speed of the drive gear 73 based on the rotation ratio of the drive gear 73, the idler gear 75, and the driven gear 74.

As described above, the power transmission device of the present disclosure is a power transmission device (20, 20B, 20C) mounted on a vehicle, including: a rotation transmission member (40) that transmits power transmitted from a driving source (11) to an input shaft; a power connection switching mechanism (C1) that is connected to or cut off from the driving source (11) and the rotation transmission member (40); and an oil pump (60) in which rotation of either a first rotational shaft on the driving source (11) side of the power connection switching mechanism (C1) or a second rotational shaft on a driving wheel (DW) side of the power connection switching mechanism (C1) is selectively transmitted to drive the oil pump (60). The oil pump (60) is coupled to the second rotational shaft via a gear transmission mechanism (72) in which a plurality of gears mesh with each other. A first rotation ratio of the first rotational shaft and the oil pump (60), a second rotation ratio of the second rotational shaft and the oil pump (60) are different.

In the power transmission device of the present disclosure, the oil pump is coupled to the second rotational shaft on the driving wheel side of the power connection switching mechanism via a gear transmission mechanism in which a plurality of gears are meshed. The first rotation ratio of the first rotational shaft on the driving source side of the power connection switching mechanism and the oil pump, and the second rotation ratio of the second rotational shaft and the oil pump are different. Thus, since the second rotational shaft and the oil pump are coupled via the gear transmission mechanism, it is possible to facilitate adjustment of the relationship between the first rotation ratio and the second rotation ratio (for example, the first rotation ratio divided by the second rotation ratio). That is, the relationship between the first rotation ratio and the second rotation ratio can have more flexibility.

The power transmission device of the present disclosure may further include a transmission case (80) having an inner wall portion (81w) that is extended radially inward from an inner peripheral surface and that supports the rotation transmission member (40), in which the second rotational shaft and the gear transmission mechanism (72) are positioned between the inner wall portion (81w) and the rotation transmission member (40) in an axial direction of the rotation transmission member (40). In such a case, when a wrapping transfer mechanism is used instead of a gear transmission mechanism, the chain is hidden by the inner wall portion and the rotation transmission member and an operator cannot perform visual inspection, which makes assembling difficult. In contrast, by using a gear transmission mechanism, there is no need for assembling while looping around the chain, which improves the assemblability.

In the power transmission device of the present disclosure, the gear transmission mechanism (72) may have a drive gear (73) attached to the second rotational shaft and a driven gear (74) attached to the oil pump (60), the drive gear (73) may be supported by the rotation transmission member (40), and the driven gear (74) may be supported by a rotational shaft of the oil pump (60) fixed by the transmission case (80). In this way, with driven gear on the transmission case side, the drive gear can be easily assembled later with the rotation transmission member.

In the power transmission device of the present disclosure, the gear transmission mechanism (72) may have a drive gear (73) attached to the second rotational shaft, a driven gear (74) attached to the oil pump (60), and an idler gear (75) meshed with the drive gear (73) and the driven gear (74). By using the idler gear, the rotation directions of the first rotational shaft, the second rotational shaft, and the oil pump during forward traveling can be matched. In such a case, a shaft center of the idler gear (75) may be provided at a position offset from a straight line connecting a shaft center of the drive gear (73) and a shaft center of the driven gear (74). In this way, it is possible to dispose the idler gear while avoiding the hydraulic servo of the brake and reduce the axial length of the power transfer device and reduce the length of the straight line connecting the shaft center of the drive gear and the shaft center of the driven gear. In such a case, the shaft center of the idler gear (75) may be offset from the straight line so as to be close to a differential shaft (59).

In the power transmission device of the present disclosure, the rotation transmission member (40) may be a continuously variable transmission (40) that changes a speed of power in a stepless manner and transmits power between a primary shaft (42) and a secondary shaft (44), and may have a forward/reverse travel switching mechanism (30) connected to the driving source (11) and the primary shaft (42).

In the power transmission device of the present disclosure, the forward/reverse travel switching mechanism (30) may have: a planetary gear mechanism having a first rotation element (31s) connected to the driving source (11), a second rotation element (31r), and a third rotation element (31c) connected to the primary shaft (42); a clutch (C1) that connects any two of the first rotation element (31s), the second rotation element (31r), and the third rotation element (31c) to each other and disconnects the two from each other; and a brake (B1) that fixes the second rotation element (31r) to the transmission case (80) so that the second rotation element (31r) is stationary and that disengages the second rotation element (31r) from the transmission case (80). The power connection switching mechanism may be the clutch (C1), the gear transmission mechanism (72) may have a drive gear (73) attached to the second rotational shaft, a driven gear (74) attached to the oil pump (60), and an idler gear (75) meshed with the drive gear (73) and the driven gear (74), and a shaft center of the idler gear (75) may be provided on an outer diameter from the brake (B1). In such a case, the inner wall portion (81w) may have an annular oil chamber forming portion (81o) that forms an oil chamber of the brake (B1) and an extended portion (81e) that projects to an outer diameter side from the oil chamber forming portion (81o), and the idler gear (75) may be shaft-supported by the extended portion (81e) so as to be rotatable. Thus, the idler gear can be shaft-supported so as to be rotatable, with the extended portion, by effectively utilizing the space on the outer peripheral side of the oil chamber forming portion while avoiding the oil chamber of the brake. In this way, it is possible to reduce the axial length of the power transmission device.

In the power transmission device of the present disclosure, the continuously variable transmission (40) may have a primary pulley (43) that rotates integrally with the primary shaft (42) and a secondary pulley (45) that rotates integrally with the secondary shaft (44), and the drive gear (73) may be mounted on the primary shaft (42) between the primary pulley (43) and the forward/reverse travel switching mechanism (30).

In the power transmitting device of the present disclosure in which the rotation transmission member is a continuously variable transmission, the continuously variable transmission (40) may have a primary pulley (43) that rotates integrally with the primary shaft (42) and a secondary pulley (45) that rotates integrally with the secondary shaft (44), the primary pulley (43) may have a fixed sheave (43a) formed integrally with the primary shaft (42) and a movable sheave (43b) slidably supported by the primary shaft (42) in an axial direction of the continuously variable transmission (40), and the drive gear (73) may be formed integrally with the fixed sheave (43b).

The power transmission device of the present disclosure may further include a rotation speed sensor (90) that senses a tooth of a drive gear (73) attached to the second rotational shaft among the plurality of gears of the gear transmission mechanism (72) to detect a rotation speed of the second rotational shaft. In this way, since a speed sensor dedicated to a rotor does not need to be provided, the number of parts can be reduced.

In the power transmission device of the present disclosure, the first rotational shaft may be a rotational shaft coupled to a pump impeller (23p) of a starting device (23) that has the pump impeller (23p) connected to the driving source (11) and a turbine runner (23t) connected to the forward/reverse travel switching mechanism (30).

Although the embodiments of the present disclosure are described above, it is to be understood that the invention of the present disclosure is not limited in any way to the embodiments and may be carried out in various forms without departing from the spirit and scope of the present disclosure.

### INDUSTRIAL APPLICABILITY

The present disclosure is applicable to the power transmission device manufacturing industry and the like.

1. A power transmission device mounted on a vehicle, comprising:
a rotation transmission member that transmits power transmitted from a driving source to an input shaft;
a power connection switching mechanism that is connected to or cut off from the driving source and the rotation transmission member; and
an oil pump to which rotation of either a first rotational shaft on a driving source side of the power connection switching mechanism or a second rotational shaft on a driving wheel side of the power connection switching mechanism is selectively transmitted to drive the oil pump, wherein
the oil pump is coupled to the second rotational shaft via a gear transmission mechanism in which a plurality of gears mesh with each other, and
a first rotation ratio of the first rotational shaft and the oil pump, and a second rotation ratio of the second rotational shaft and the oil pump are different.

2. The power transmission device according to claim 1, further comprising a transmission case having an inner wall portion that is extended radially inward from an inner peripheral surface and that supports the rotation transmission member, wherein
the second rotational shaft and the gear transmission mechanism are positioned between the inner wall portion and the rotation transmission member in an axial direction of the rotation transmission member.

3. The power transmission device according to claim 1, wherein
the gear transmission mechanism has a drive gear attached to the second rotational shaft and a driven gear attached to the oil pump,
the drive gear is supported by the rotation transmission member, and
the driven gear is supported by a rotational shaft of the oil pump fixed by the transmission case.

4. The power transmission device according to claim 1, wherein
the gear transmission mechanism has a drive gear attached to the second rotational shaft, a driven gear attached to the oil pump, and an idler gear meshed with the drive gear and the driven gear.

5. The power transmission device according to claim 4, wherein a shaft center of the idler gear is provided at a position offset from a straight line connecting a shaft center of the drive gear and a shaft center of the driven gear.

6. The power transmission device according to claim 5, wherein the shaft center of the idler gear is offset from the straight line so as to be close to a differential shaft.

7. The power transmission device according to claim 1, wherein
the rotation transmission member is a continuously variable transmission that changes a speed of power in a stepless manner and transmits power between a primary shaft and a secondary shaft, and has
a forward/reverse travel switching mechanism connected to the driving source and the primary shaft is provided.

8. The power transmission device according to claim 7, wherein
the forward/reverse travel switching mechanism has:
a planetary gear mechanism having a first rotation element connected to the driving source, a second rotation element, and a third rotation element connected to the primary shaft;
a clutch that connects any two of the first rotation element, the second rotation element, and the third rotation element to each other and disconnects the two from each other; and
a brake that fixes the second rotation element to the transmission case so that the second rotation element is stationary and that disengages the second rotation element from the transmission case,
the power connection switching mechanism is the clutch,
the gear transmission mechanism has a drive gear attached to the second rotational shaft, a driven gear attached to the oil pump, and an idler gear meshed with the drive gear and the driven gear, and
a shaft center of the idler gear is provided on an outer diameter from the brake.

9. The power transmission device according to claim 8, wherein
the inner wall portion has an annular oil chamber forming portion that forms an oil chamber of the brake and an extended portion that projects to an outer diameter side from the oil chamber forming portion, and
the idler gear is shaft-supported by the extended portion so as to be rotatable.

10. The power transmission device according to claim 7, wherein
the continuously variable transmission has a primary pulley that rotates integrally with the primary shaft and a secondary pulley that rotates integrally with the secondary shaft, and
the drive gear is mounted on the primary shaft between the primary pulley and the forward/reverse travel switching mechanism.

11. The power transmission device according to claim 7, wherein
the continuously variable transmission has a primary pulley that rotates integrally with the primary shaft and a secondary pulley that rotates integrally with the secondary shaft,
the primary pulley has a fixed sheave formed integrally with the primary shaft and a movable sheave slidably supported by the primary shaft in an axial direction of the continuously variable transmission, and
the drive gear is formed integrally with the fixed sheave.

12. The power transmission device according to claim 1, further comprising a rotation speed sensor that senses a tooth of a drive gear attached to the second rotational shaft among the plurality of gears of the gear transmission mechanism to detect a rotation speed of the second rotational shaft.

13. The power transmission device according to claim 1, wherein the first rotational shaft is a rotational shaft coupled to a pump impeller of a starting device that has the pump impeller connected to the driving source and a turbine runner connected to the forward/reverse travel switching mechanism.
